(19) United States
(12) Patent Application Publication
(10) Pub. No.: US 2008/0307592 A1
(43) Pub. Date: Dec. 18, 2008

(54) Biodegradable, chemical toliet training and cleaning system

(76) Inventor: Daniel Joseph Cornelius, Taft, TN (US)

Correspondence Address: DANIEL CORNELIUS, 9 BLANCHE CIRCLE, TAFT, TN, 38488, US

(21) Appl. No.: 11/703,031

(22) Filed: Jun. 18, 2007

(51) Int. Cl. B08B 1/00; C11D 17/02

(52) U.S. Cl. 15/104.93; 510/191

(57) ABSTRACT

an organic toilet cleaner/freshener made of biodegradable foam that also serves as a toilet training target for 2-4 year old children.

Non-toxic, water-soluble, bio-degradable foam toilet cleaner and septic tank biologic matter breakdown agent that also serves as a toilet training aid.

### CROSS-REFERENCE TO RELATED APPLICATION

None

### STATEMENT REGARDING FEDERALLY SPONSORED RESEARCH OR DEVELOPMENT

No Federal research or development funds were used in the development of this concept/product.

### REFERENCE TO SEQUENCE LISTING, A TABLE OR A COMPUTER PROGRAM LISTING COMPACT DISC APPENDIX

None

### BACKGROUND OF THE INVENTION

Life in a rural setting made the necessity for such a product apparent. There are few products available that effectively clean/accelerate the waste breakdown process in septic systems that are also user friendly and completely organic in composition. Furthermore, raising three sons challenged my ability to conduct effective toilet training. My solution was to drop dead bugs into the toilet so that my sons could use them for urinary target practice. This new product acts as a safe, dual purpose “training target” that disinfects the toilet bowl and helps breakdown waste matter in the septic tank. It is also 100% organic and does not harm the local environment (ground water, soil, etc.).

### BRIEF SUMMARY OF THE INVENTION

Highly porous biodegradable (organic) foam figures impregnated with Gramicid, yeast and hollowed out to contain a pellet of baking soda. Used to clean toilet bowls and also accelerate waste matter breakdown in septic systems. Secondary purpose is to provide a harmless target for 2-4 year old children's toilet training.

### BRIEF DESCRIPTION OF THE SEVERAL VIEWS OF THE DRAWING

FIG. 1 depicts a cross section of the foam shape with the baking soda pellet imbedded inside

FIG. 2 shows the coloration process and blending of the chemical mix through a two-stage injection process.

FIG. 3a-e, illustrates the possible foam shapes

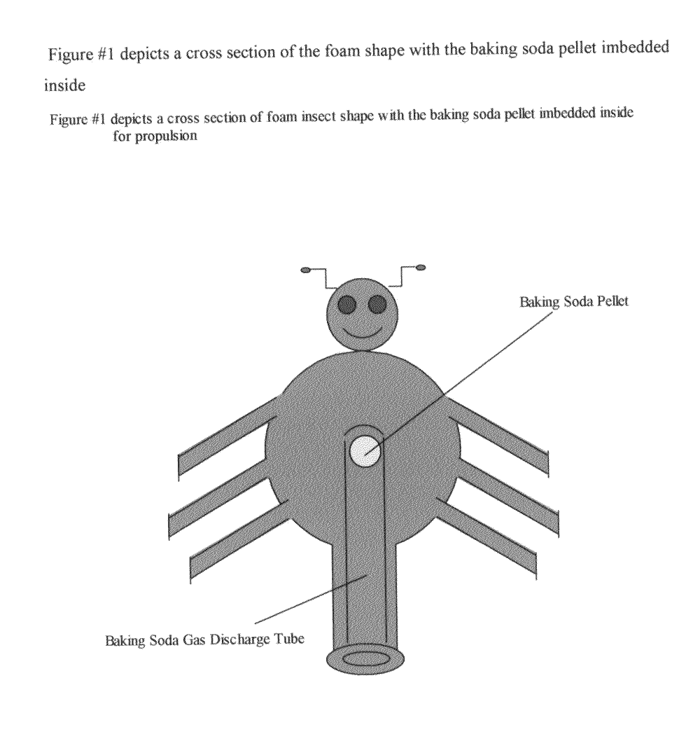

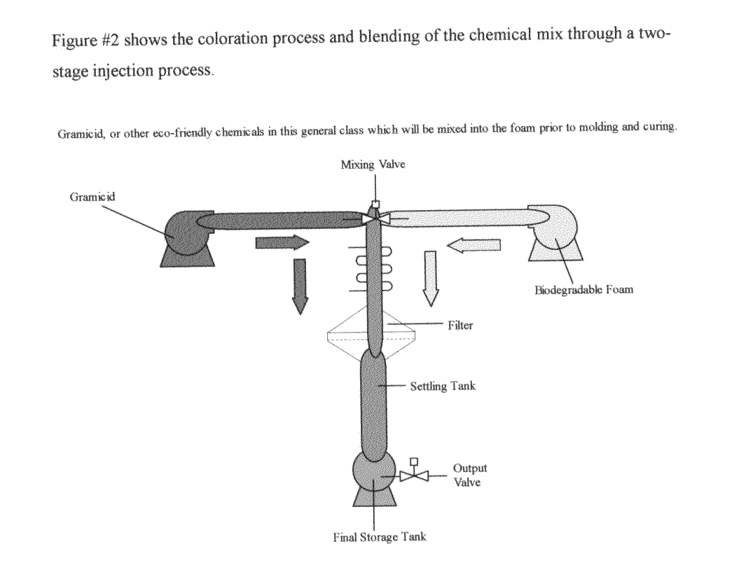

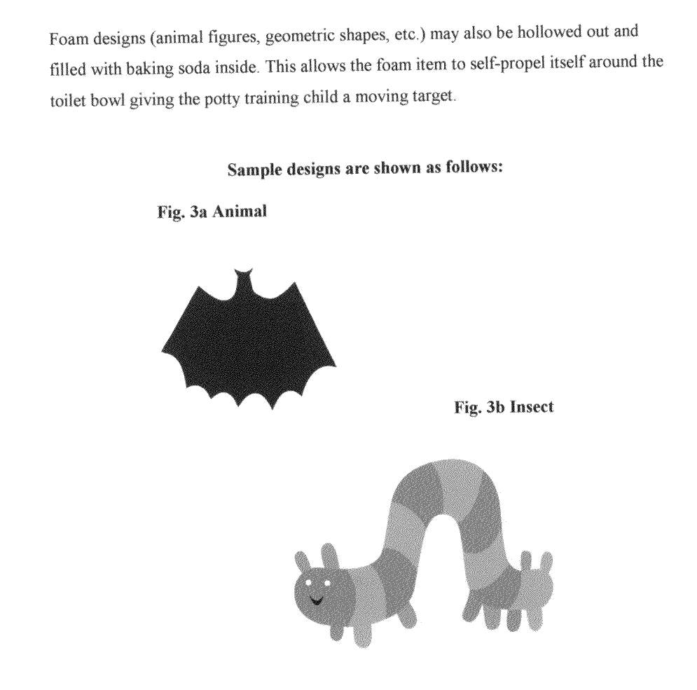

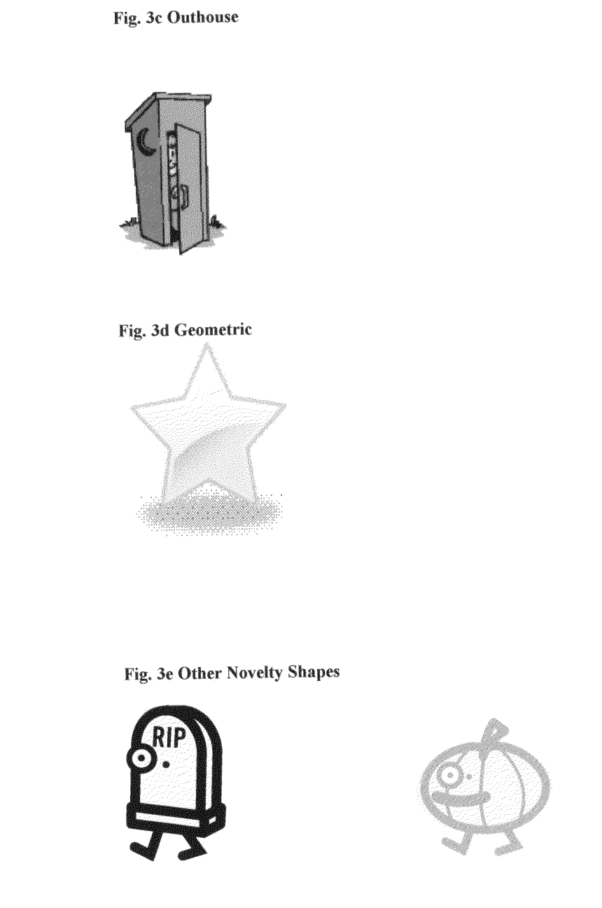

### DETAILED DESCRIPTION OF THE INVENTION

Non-toxic, water-soluble, bio-degradable foam toilet cleaner and septic tank biologic matter breakdown agent. This accelerant will be a highly porous, foam item that may be created in multiple shapes and sizes through injection molding or pouring liquid foam into pans for curing. Key design and manufacturing characteristics:
1) Incorporates organic compounds—yeast (impregnated into the foam) to help breakdown waste in septic tanks;
2) Uses non-toxic compounds to freshen and disinfect toilet bowls, tubs and urinals. Candidate chemical family includes Gramicid, or other eco-friendly chemicals in this general class which will be mixed into the foam prior to molding and curing. The main purpose of Gramicid (or chemicals from the Gramicid family/category) is to disinfect and mask unpleasant odors.
3) The toilet cleaner/trainer may be molded/shaped into a large number of novelty items to assist/encourage children during toilet training.

Foam designs (animal figures, geometric shapes, etc.) may also be hollowed out and filled with baking soda inside. This allows the foam item to self-propel itself around the toilet bowl giving the potty training child a moving target.

1. The Biodegradable, Chemical Toilet Cleaning and Training System (hereafter known as the BCTCTS) is unique in that it fuses multiple functions into a single design entity. Currently, a non-toxic, water-soluble, bio-degradable foam toilet cleaner that also incorporates a septic tank biologic matter breakdown agent—all captured in a single, disposable foam application does not exist. The BCTCTS uses highly porous, foam as the transport medium allowing the proprietary blend of organic compounds and chemicals to react with water in the toilet bowl and effluent in the septic system. The BCTCTS may be created in multiple shapes and sizes through injection molding or by pouring pre-mixed liquid organic foam into pans for curing. Key design and manufacturing characteristics are:
I. Incorporates organic compounds—yeast (impregnated into the foam) to help breakdown waste in septic tanks;
II. Uses non-toxic compounds to freshen and disinfect toilet bowls, tubs and urinals.
III. Candidate chemical family includes Gramicid, or other eco-friendly chemicals in this general class which will be mixed into the foam prior to molding and curing.
IV. The main purpose of Gramicid (or chemicals from the Gramicid family/category) is to disinfect and mask unpleasant odors.
V. The toilet cleaner/trainer is also a novelty item to assist/encourage children during toilet training.
VI. Foam designs (animal figures, geometric shapes, etc.) may also be hollowed out and filled with baking soda inside.
VII. This allows the foam item to self-propel itself around the toilet bowl giving the potty training child a moving target.
